(19) United States
(12) Patent Application Publication
(10) Pub. No.: US 2002/0090211 A1
(43) Pub. Date: Jul. 11, 2002

(54) Apparatus for implementing readout of fingerprint

(76) Inventor: Yukito Kawahara, Chiba-shi (JP)

Correspondence Address: ADAMS & WILKS, 31st Floor, 50 Broadway, New York, NY, 10004, US

(21) Appl. No.: 10/015,405

(22) Filed: Dec. 12, 2001

(30) Foreign Application Priority Data
Jan. 9, 2001 (JP) 2001-001678

(51) Int. Cl. G03B 29/00

(52) U.S. Cl. 396/15

(57) ABSTRACT

An apparatus for implementing readout of a fingerprint irradiates a fingertip with light via a transparent base plate. When implementing touch-and-move of the finger on the transparent base plate, an image sensor of a slim piece implements readout of reflected light formed by the asperity of the fingerprint.

### BACKGROUND OF THE INVENTION

1. Field of the Invention

The present invention relates to an apparatus for implementing readout of intrinsic biological information such as a fingerprint and the like for identifying an individual, which is used in electronic commerce and the like.

2. Description of the Related Art

An apparatus for implementing readout of a fingerprint conventionally known uses a capacitance-type semiconductor sensor for detecting a skin asperity forming the fingerprint of a fingertip from a difference in the capacitance size between the fingertip and a plurality of microelectrodes of the readout apparatus.

In this conventional technique, only an insulation film of a thickness of approximately 1 μm is provided between the fingertip and plural microelectrodes of the semiconductor sensor of the readout apparatus. Therefore, there is a problem in that an electrostatic withstand pressure is low, and that an insulation breakdown easily occurs due to static electricity. Furthermore, there is another problem that the manufacturing cost is high since the apparatus needs a semiconductor sensor with a size of 1.5 cm×1.5 cm or more to implement the readout of the fingerprint on a detecting surface with a size of approximately 1.5 cm×1.5 cm.

### SUMMARY OF THE INVENTION

To solve the above-described problems, the present invention irradiates the fingertip with light via a transparent base plate to implement readout of the asperity of the fingertip by the light reflected from the irradiated light. This invention applies an image sensor of a slim piece for implementing the readout of a fingerprint, wherein the transparent base plate is used by touch-and-move of the finger.

### BRIEF DESCRIPTION OF THE DRAWINGS

In the accompanying drawings:

FIG. 1 is a perspective view showing readout apparatus according to the present invention;

FIG. 2 is a sectional view showing the readout apparatus according to the present invention;

FIG. 3 is a sectional view showing another readout apparatus according to the present invention;

FIG. 4 is a sectional view showing another readout apparatus according to the present invention;

FIG. 5 is a sectional view showing still another readout apparatus including another form of a light source according to the present invention;

FIG. 6 is another sectional view showing the readout apparatus designated in FIG. 1 according to the present invention;

FIG. 7 is a plan view showing a base plate of the readout apparatus and an image sensor of the readout apparatus according to the present invention; and

FIG. 8 is a sectional view showing the case where the readout apparatus according to the present invention implements readout of manuscripts.

### DESCRIPTION OF THE PREFERRED EMBODIMENTS

An embodiment of the present invention will be described in detail with reference to the drawings.

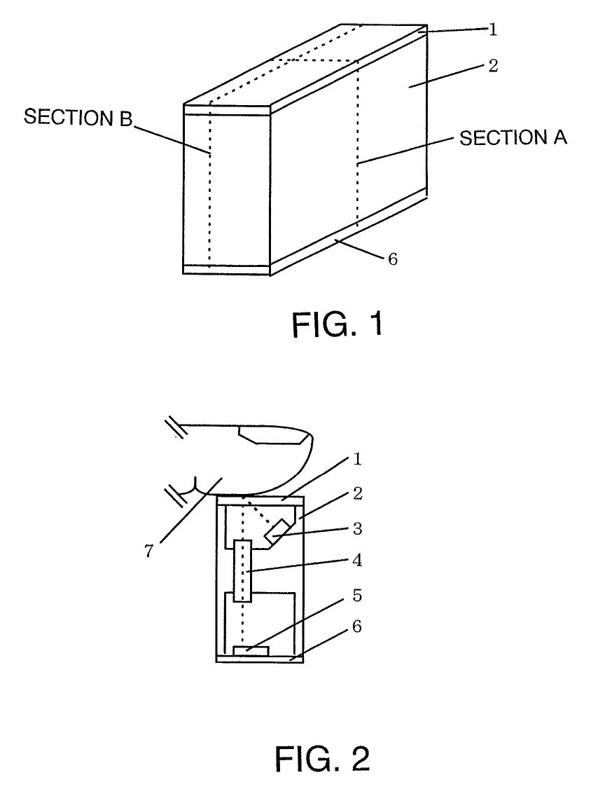

FIG. 1 is a perspective view showing readout apparatus of an embodiment of the present invention. FIG. 1 shows a transparent base plate 1 for implementing touch-and-move of a finger; a housing 2 for accommodating a light source, an equal magnification lens, and an image sensor; and a base plate 6 for fixing the image sensor.

FIG. 2 shows the inner sectional surface A according to the present embodiment. Referring to FIG. 2, a light irradiated from a light source 3 undergoes irregular reflection on the surface of a finger 7. The reflected light forms an image on an image pickup surface of an image sensor 5 via an equal magnification lens 4. Since the image pickup surface of the image sensor 5 is of a slim rectangular shape, the surface can form only a part of the image of the fingerprint which has been formed via the equal magnification lens 4. However, when implementing touch-and-move of a finger on the transparent base plate 1, the image sensor 5 can implement the readout of the whole image of the fingerprint with the image sensor 5. In the case of FIG. 2, the asperity of the fingerprint can be read by the contrast of the reflected light which has undergone irregular reflection, wherein the contrast is usually low. However, this configuration makes it possible to easily implement the readout of books or manuscripts. An LED is used as the light source and when the LED employs a visible light or an infrared light including a plurality of colors such as green or blue without restricting the color to a single color such as red, the LED can implement the readout of various conditions of a skin. The image sensor 5 usually employs the image sensor composed of single crystal silicon. However, when employing the image sensor composed of amorphous silicon, this invention can employ a long image sensor or an image sensor without the equal magnification lens.

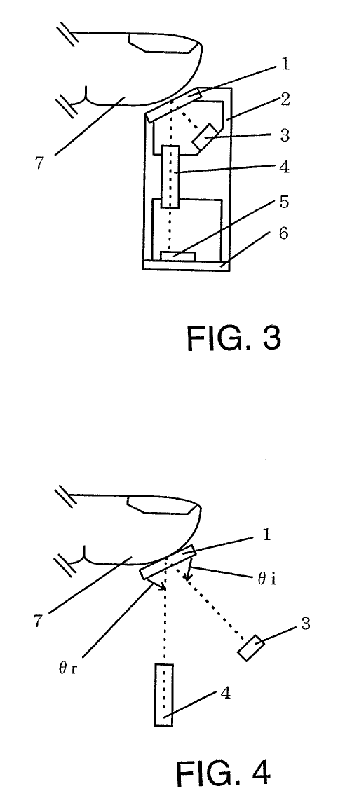

FIGS. 3 and 4 show another embodiment of the present invention. The apparatus according to this embodiment is configured so that the angle of incidence of light θi becomes equal to the angle of reflection θr at the surface of a transparent base plate 1 touched by the finger. This configuration can improve the contrast in the readout of the asperity of the fingerprint.

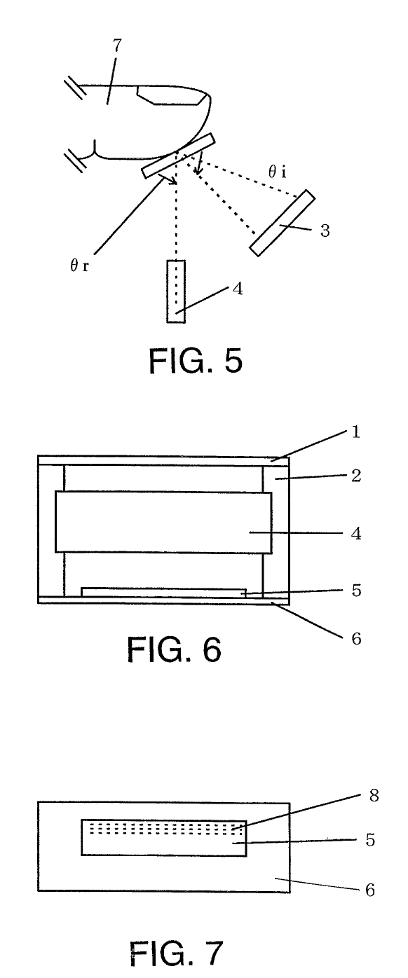

The other embodiment shown in FIG. 5 includes a different form of the light source 3 from that shown above. In FIG. 5, there is employed a configuration where the angle of incidence of light θi on the finger becomes smaller than the angle of reflection θr. Therefore, this apparatus can easily implement the readout of manuscripts such as magazines and the like as well as fingerprints.

FIG. 6 designates the section B of the perspective view of the present invention shown in FIG. 1. Referring to FIG. 6, the equal magnification lens 4 has a length approximately equal to the finger width. The width of the readout section of the image sensor 5 is approximately the same as the length of the equal magnification lens 4, so that the image of the fingerprint is formed on an image pickup surface of the image sensor 5 via the equal magnification lens 4.

FIG. 7 designates the base plate 6 and the image sensor 5 disposed thereon. The image sensor 5 includes an image pickup surface 8 composed of a plurality of photoreceptors linearly disposed thereon.

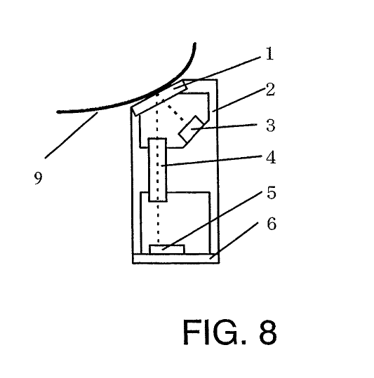

FIG. 8 designates the case of implementing readout of a manuscript 9 such as a magazine instead of the finger 7.

As described above, the present invention can improve the electrostatic withstand pressure without being affected by static electricity. Furthermore, the present invention can reduce the manufacturing cost, because this invention applies an image sensor of a slim piece for implementing the readout of the fingerprint, and it is configured to implement touch-and-move of a finger on the transparent base plate. Still further, the present invention can implement the readout of manuscripts such as magazines as well as fingerprints. Therefore, the present invention can further implement the readout of URLs and the like or business cards.

What is claimed is:

1. An apparatus for implementing readout of a fingerprint, comprising:
a transparent base plate having a contact surface touched by a fingertip of a person;
a light source for irradiating the contact surface with light;
an equal magnification lens for forming an image of the fingerprint of the fingertip from reflected light in equal magnification;
an image sensor for detecting the fingerprint formed into an image by an image pickup surface composed of a plurality of photoreceptors linearly disposed thereon;
a base plate for holding the image sensor; and
a housing for fixing the transparent base plate, the light source, the equal magnification lens and the base plate.

2. An apparatus for implementing readout of a fingerprint according to claim 1, wherein the angle of reflection of the reflected light with respect to the fingerprint forming an image on the image pickup surface of the image sensor is larger than or approximately equal to the angle of incidence.

3. An apparatus for implementing readout of a fingerprint according to claim 1, wherein in the image pickup surface of the image sensor, a transverse length X corresponding to the row length is more than ten times larger than a longitudinal length Y corresponding to the column length.

4. An apparatus for implementing readout of a fingerprint according to claim 1, wherein the light source is composed of LEDs of two colors or more.

5. An apparatus for implementing readout of a fingerprint according to claim 1, wherein the image pickup device is formed of amorphous silicon.

6. An apparatus for implementing readout of a fingerprint according to claim 1, wherein the angle of incidence of the irradiated light with respect to the fingerprint, is approximately equal to the angle of reflection of the reflected light with respect to the fingerprint forming the image on the image pickup surface of the image sensor, or the angle of incidence is smaller than the angle of reflection.
